(19) United States
(12) Patent Application Publication
(10) Pub. No.: US 2026/0228250 A1
(43) Pub. Date: Aug. 6, 2026

(54) INFORMATION PROCESSING DEVICE AND INFORMATION PROCESSING METHOD

(71) Applicant: Semiconductor Energy Laboratory Co., Ltd., Atsugi-shi (JP)

(72) Inventors: Kengo AKIMOTO, Isehara (JP); Junpei MOMO, Sagamihara (JP)

(21) Appl. No.: 19/453,040

(22) Filed: Jan. 20, 2026

(30) Foreign Application Priority Data
Feb. 6, 2025 (JP) 2025-018155

(51) Int. Cl. G06F 16/3329; G06V 30/422

(52) U.S. Cl. CPC G06F 16/3329; G06V 30/422

(57) ABSTRACT

An information processing device capable of creating a highly complete document is provided. After a document and a drawing are received, a reference numeral is obtained from the drawing. Next, a name of a component denoted by the reference numeral is obtained from the document, and then a passage including the name and the reference numeral is obtained from the document. After that, a first representation is obtained using a graph description language on the basis of the obtained reference numeral, name, and passage. The first representation represents a graph including two or more nodes and one or more edges. A node represents a component, and an edge represents a relation between two nodes. When the first representation includes an isolated node, the passage is modified by the language model so that the isolated node is excluded from the first representation. When the first representation does not include the isolated node, the graph is presented to the user. When the user modifies the graph, the passage is modified by the language model on the basis of the modified graph. When the graph is not modified, the passage is output.

### BACKGROUND OF THE INVENTION

### 1. Field of the Invention

One embodiment of the present invention relates to an information processing device. Another embodiment of the present invention relates to an information processing method using an information processing device. Another embodiment of the present invention relates to an information processing system including an information processing device.

Note that one embodiment of the present invention is not limited to the above technical field. The technical field of one embodiment of the invention disclosed in this specification and the like relates to an object, a method, or a manufacturing method. Alternatively, one embodiment of the present invention relates to a process, a machine, manufacture, or a composition of matter. Specific examples of the technical field of one embodiment of the present invention disclosed in this specification include an information processing device, a semiconductor device, a memory device, a driving method thereof, and a manufacturing method thereof.

### 2. Description of the Related Art

Documents for patent applications, e.g., patent specifications need to be written to contain a technical concept while satisfying the written description requirement. This requires high-level knowledge and skill related to intellectual property and is difficult for an inexperienced person. Patent Document 1 discloses a method for automatically complementing the description of a patent specification.

In recent years, language models using artificial neural networks (ANNs, hereinafter also simply referred to as neural networks) have been actively developed, and large language models (LLMs) in particular have attracted attention. A large language model is a natural language processing model learned using a large amount of data. With a large language model, a communication model that gives an answer to a user's instruction can be achieved, for example. In Non-Patent Document 1, generative pre-trained transformer 4 (GPT-4, registered trademark) is disclosed as a large language model, and ChatGPT is disclosed as a communication model. Other examples of large language models include LaMDA (Language Model for Dialogue Applications), PaLM (Pathways Language Model), Llama2, and Llama3.

### References

[Patent Document 1] Japanese Published Patent Application No. 2022-24112

[Non-Patent Document 1] Summary of ChatGPT/GPT-4 Research and Perspective Towards the Future of Large Language Models, Yiheng Liu et al., submitted on 4 Apr. 2023 [online], Internet URL: https://arxiv.org/abs/2304.01852

### SUMMARY OF THE INVENTION

For example, in order to broaden the scope of protectable rights in a patent application, a patent specification must comprehensively cover all components depicted in patent drawings. This requires an enormous amount of workload.

In view of the above, an object of one embodiment of the present invention is to provide an information processing device, an information processing method, and an information processing system that are capable of creating a highly complete document. Another object of one embodiment of the present invention is to provide an information processing device, an information processing method, and an information processing system that enable a user to create a document with a small amount of workload.

Another object of one embodiment of the present invention is to provide an information processing device, an information processing method, and an information processing system that are highly convenient and useful. Another object of one embodiment of the present invention is to provide a novel information processing device, a novel information processing method, and a novel information processing system.

Note that the description of these objects does not preclude the existence of other objects. One embodiment of the present invention does not need to achieve all these objects. Other objects will be apparent from and can be derived from the description of the specification, the drawings, the claims, and the like.

One embodiment of the present invention is an information processing method including the following steps: receiving a drawing and a document; by referring to a reference numeral obtained from the drawing, a name of a component that is obtained from the document and denoted by the reference numeral, and a passage that is obtained from the document and includes the name and the reference numeral, obtaining a first representation including a node representing the component by using a graph description language; obtaining a first modified passage by transmitting, to a language model, a first prompt for modifying the passage so that an isolated node is excluded from the first representation; obtaining a second representation by using the graph description language and by referring to the reference numeral, the name, and the first modified passage; presenting a graph represented by the second representation; receiving a modified graph; obtaining a second modified passage by transmitting, to the language model, a second prompt for modifying the first modified passage by referring to the modified graph; and outputting the second modified passage.

Another embodiment of the present invention is an information processing method including a first to ninth steps. In the first step, a drawing and a document are received. In the second step, a reference numeral is obtained from the drawing. In the third step, a name of a component denoted by the reference numeral is obtained from the document. In the fourth step, a passage including the name and the reference numeral is obtained from the document. In the fifth step, a first representation is obtained by using a graph description language and by referring to the reference numeral, the name, and the passage. The first representation represents a graph including at least two nodes and at least one edge. A node represents a component. An edge represents a relation between two nodes. When the first representation includes an isolated node, a first prompt for modifying the passage so that the isolated node is excluded from the first representation is created and transmitted to a language model to obtain a first modified passage in the sixth step, and then the fifth step is performed using the first modified passage. When the first representation does not include the isolated node, the graph is presented in the seventh step. When the graph is modified, a second prompt for modifying the passage by referring to the modified graph is created and transmitted to the language model to obtain a second modified passage in the eighth step, and then the seventh step is performed using the second modified passage. When the graph is not modified, the passage is output in the ninth step.

In the above embodiment, the drawing and the passage may be presented in the seventh step.

In the above embodiment, the first representation may be obtained in the fifth step by creating a third prompt for generating the first representation and transmitting the third prompt to the language model.

Another embodiment of the present invention is an information processing device including a reception unit, an output unit, and a processing unit. The reception unit is configured to receive a document and a drawing. The processing unit is configured to perform processes of obtaining a reference numeral from the drawing; obtaining a name of a component denoted by the reference numeral from the document; obtaining a passage including the name and the reference numeral from the document; obtaining a first representation representing a graph including at least two nodes and at least one edge by using a graph description language and by referring to the reference numeral, the name, and the passage; when the first representation includes an isolated node, creating a first prompt for modifying the passage so that the isolated node is excluded from the first representation; when the first representation does not include the isolated node, presenting the graph to a user; and when the graph is modified, creating a second prompt for modifying the passage by referring to the modified graph. The output unit is configured to supply the first prompt and the second prompt to the language model. The output unit is configured to output the passage. A node represents a component. An edge represents a relation between two nodes.

In the above embodiment, the processing unit may be configured to perform a process of presenting the drawing and the passage to the user while presenting the graph to the user.

In the above embodiment, the processing unit may be configured to perform a process of creating a third prompt for generating the first representation, and the output unit may be configured to supply the third prompt to the language model.

In the above embodiment, the document may be a specification for a patent application or a specification for a utility model registration application, and the drawing may relate to the patent application or the utility model registration application.

In the above embodiment, the graph description language may be a DOT language.

One embodiment of the present invention can provide an information processing device, an information processing method, and an information processing system that are capable of creating a highly complete document. Another embodiment of the present invention can provide an information processing device, an information processing method, and an information processing system that enable a user to create a document with a small amount of workload.

Another embodiment of the present invention can provide an information processing device, an information processing method, and an information processing system that are highly convenient and useful. Another embodiment of the present invention can provide a novel information processing device, a novel information processing method, and a novel information processing system.

Note that the description of these effects does not preclude the existence of other effects. One embodiment of the present invention does not necessarily have all these effects. Other effects will be apparent from and can be derived from the description of the specification, the drawings, the claims, and the like.

### BRIEF DESCRIPTION OF THE DRAWINGS

In the accompanying drawings:

FIG. 1 is a schematic diagram illustrating an example of an information processing system;

FIG. 2 is a block diagram illustrating an example of an information processing system;

FIG. 3 is a flow chart showing an example of an information processing method;

FIGS. 4A and 4B are flow chart showing examples of an information processing method;

FIG. 5 is a schematic diagram illustrating an example of data;

FIGS. 6A and 6B are schematic diagrams each illustrating a representation in a graph description language;

FIG. 7 is a schematic diagram illustrating an example of a GUI; and

FIG. 8 is a schematic diagram illustrating an example of a GUI.

### DETAILED DESCRIPTION OF THE INVENTION

Embodiment will be described in detail with reference to the drawings. Note that the present invention is not limited to the following description, and it will be readily appreciated by those skilled in the art that modes and details of the present invention can be modified in various ways without departing from the spirit and scope of the present invention. Therefore, the present invention should not be construed as being limited to the description in the following embodiment. Note that in structures of the invention described below, the same portions or portions having similar functions are denoted by the same reference numerals in different drawings, and the description thereof is not repeated.

Although a block diagram in which components are classified by their functions and shown as independent blocks is shown in drawings attached to this specification, it is difficult to completely separate actual components according to their functions and one component can relate to a plurality of functions.

In this specification and the like, the terms “first” and “second” are sometimes used for easy understanding of the technical contents or identification of components. Thus, the terms “first” and “second” do not limit the number of components. Moreover, the terms “first” and “second” do not limit the order of components. In addition, the terms such as “first” and “second” or identification numerals used in this specification do not correspond to the terms or the identification numerals in the scope of claims of this application in some cases.

### Embodiment

This embodiment will describe an information processing system of one embodiment of the present invention. This embodiment will also describe an information processing device included in the information processing system and an information processing method using the information processing system.

### <Structure Example 1 of Information Processing System>

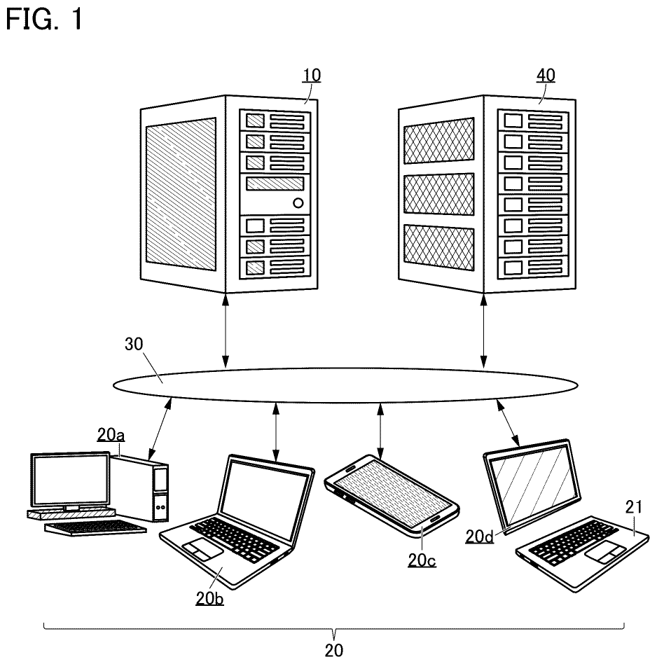

FIG. 1 is a schematic diagram illustrating a structure example of the information processing system of one embodiment of the present invention. The information processing system of one embodiment of the present invention includes an information processing device 10 and an information processing device 40. The information processing device 10 and the information processing device 40 are connected to each other via a network 30 and can transmit and receive data.

The information processing device 40 has a function of performing processing using a language model. The language model has a function of generating a response sentence on the basis of a prompt. The prompt is regarded as an input sentence for causing the language model to perform an intended operation. The prompt is supplied from the information processing device 10 to the information processing device 40, for example. The response sentence generated by the language model is supplied from the information processing device 40 to the information processing device 10, for example. Note that the information processing device 10 may have a function of performing processing using a language model.

The information processing system of one embodiment of the present invention may be configured such that the user can directly operate the information processing device 10 to input a document or the like, or may be configured such that the user can input a document or the like with an information terminal 20 connected to the information processing device 10 via the network 30, as illustrated in FIG. 1.

Structure examples of the information processing device 10, the information processing device 40, the information terminal 20, and the network 30 are described below.

### <<Structure Example of Information Processing Device 10>>

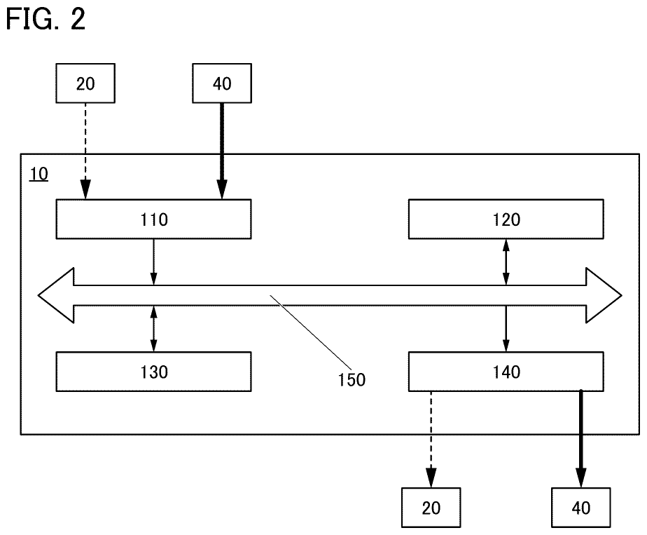

FIG. 2 is a block diagram illustrating a structure example of the information processing device 10. The information processing device 10 includes a reception unit 110, a memory unit 120, a processing unit 130, an output unit 140, and a transmission path 150. FIG. 2 also illustrates the information terminal 20 and the information processing device 40. Here, the two information terminals 20 illustrated in FIG. 2 can refer to the same information terminal. Similarly, the two information processing devices 40 illustrated in FIG. 2 can refer to the same information processing device.

### [Reception Unit 110]

The reception unit 110 has a function of receiving data from the outside of the information processing device 10. The reception unit 110 has a function of receiving data representing a document or a drawing, for example, from the information terminal 20. The reception unit 110 has a function of receiving data representing a response sentence, for example, from the information processing device 40.

The reception unit 110 has a function of supplying the received data to one or both of the memory unit 120 and the processing unit 130 via the transmission path 150. As the reception unit 110, a device such as a wired communication port, a wireless communication port, or an optical communication port can be used, for example.

### [Memory Unit 120]

The memory unit 120 has a function of storing a program to be executed by the processing unit 130. The memory unit 120 may have a function of storing data created by the processing unit 130 (e.g., an arithmetic result, an analysis result, and an inference result), data received by the reception unit 110, and the like.

The memory unit 120 may include a database. The information processing device 10 may include another database different from the memory unit 120. The information processing device 10 may have a function of extracting data from a database that is placed outside the memory unit 120, the information processing device 10, or the information processing system. The information processing device 10 may have a function of extracting data from both its own database and an external database.

One or both of a storage and a file server can be used as the memory unit 120. In addition, a database that stores paths of files retained in the file server can be used as the memory unit 120.

### [Processing Unit 130]

The processing unit 130 has a function of performing processing such as arithmetic operation, analysis, and inference with the use of data supplied from one or both of the reception unit 110 and the memory unit 120. The processing unit 130 can supply created data (e.g., an arithmetic result, an analysis result, and an inference result) to one or both of the memory unit 120 and the output unit 140. The processing unit 130 has a function of creating a prompt. Note that the processing unit 130 may have a function of performing processing using a language model.

The processing unit 130 has a function of obtaining data from the memory unit 120. The processing unit 130 may have a function of storing or registering data in the memory unit 120.

### [Output Unit 140]

The output unit 140 has a function of outputting at least one of the arithmetic result, the analysis result, and the inference result in the processing unit 130 to the outside of the information processing device 10. As the output unit 140, a device such as a wired communication port, a wireless communication port, or an optical communication port can be used, for example.

For example, the output unit 140 has a function of supplying data representing a prompt or the like to the information processing device 40. The output unit 140 also has a function of supplying data representing text or the like to the information terminal 20.

### [Transmission Path 150]

The transmission path 150 has a function of transmitting data. Data transmission and reception among the reception unit 110, the memory unit 120, the processing unit 130, and the output unit 140 can be performed via the transmission path 150. As the transmission path 150, a bus line on a motherboard, a wired communication cable, or an optical communication cable can be used, for example.

### <<Structure Example of Information Processing Device 40>>

The information processing device 40 can process the received data and transmit the processing result. For example, the information processing device 40 can perform arithmetic processing or the like using data supplied from the information processing device 10. The information processing device 40 can supply the processing result to the information processing device 10. Accordingly, arithmetic processing loads on the information processing device 10 can be reduced.

The information processing device 40 can perform processing using a language model, as described above. For example, the information processing device 40 can execute processing using a language model such as BERT or T5. The information processing device 40 can also perform processing using a language-model-based model (e.g., a text generation model or a conversation model).

The language model generates a response sentence on the basis of a prompt, as described above. For example, a prompt created by the processing unit 130 is supplied to the language model of the information processing device 40 through the output unit 140. A response sentence generated by the language model is supplied to one or both of the memory unit 120 and the output unit 140, for example, through the reception unit 110.

The information processing device 40 can execute processing using a general-purpose language processing model capable of performing a variety of natural language processing tasks.

The information processing device 40 is a large computer such as a server computer or a supercomputer. The information processing device 40 preferably has a function of a parallel computer. When the information processing device 40 is used as a parallel computer, large-scale computation necessary for artificial intelligence (AI) learning and inference can be performed, for example.

Note that the information processing device 40 is a computer having higher processing power than the information processing device 10. For example, in the case where both the information processing device 10 and the information processing device 40 have a function of a parallel computer, the information processing device 40 having higher processing power than the information processing device 10 enables larger-scale computation. For another example, in the case where both the information processing device 10 and the information processing device 40 can perform processing using a language-model-based model, the information processing device 40 can execute processing using a larger-scale model as compared with the information processing device 10.

Note that a service provider does not necessarily have its own information processing device 40. For example, a service provider can utilize part of the service that another company or the like provides using the information processing device 40.

### <<Structure Example of Information Terminal 20>>

The information terminal 20 can receive data input by the user of the information processing system of one embodiment of the present invention. The information terminal 20 can present data output from the information processing system of one embodiment of the present invention to the user by displaying the data on a display portion of the information terminal 20. Alternatively, the information terminal 20 can present data output from the information processing system of one embodiment of the present invention to the user by printing the data by a printing unit of the information terminal 20.

The information terminal 20 can supply, to the information processing device 10, data received from the user. The information terminal 20 can provide the user with data supplied from the information processing device 10.

The information terminal 20 can supply, to the information processing device 10, data created on the basis of data received from the user. The information terminal 20 can provide the user with data created on the basis of data supplied from the information processing device 10.

Dedicated application software and a web browser, for example, are installed on the information terminal 20. The user can access the information processing device 10 via the dedicated application software, the web browser, or the like. Thus, the user can enjoy a service based on the information processing system of one embodiment of the present invention by using a computer whose processing power is lower than that of the information processing device 10, for example, as the information terminal 20.

The information terminal 20 can also be referred to as a client computer or the like. Any type of the information terminal 20 is an information terminal used by the user of the information processing system of one embodiment of the present invention.

For example, a desktop computer 20a, a notebook computer 20b, a smartphone 20c, or a tablet computer 20d can be used as the information terminal 20. Note that the tablet computer 20d can also be used as a notebook computer when connected to a housing 21 including a keyboard.

### <<Network 30>>

The network 30 connects the information processing device 10 and the information processing device 40. The network 30 also connects a plurality of the information terminals 20 to the information processing device 10. Thus, input data and processed data can be transmitted and received between the information processing devices 10 and 40 and between the information terminals 20 and the information processing device 10. Furthermore, information processing loads can be dispersed.

An information processing method using the information processing system illustrated in FIG. 1 and FIG. 2 is described below. Specifically, a method for operating the information processing device 10 is described.

### <Information Processing Method>

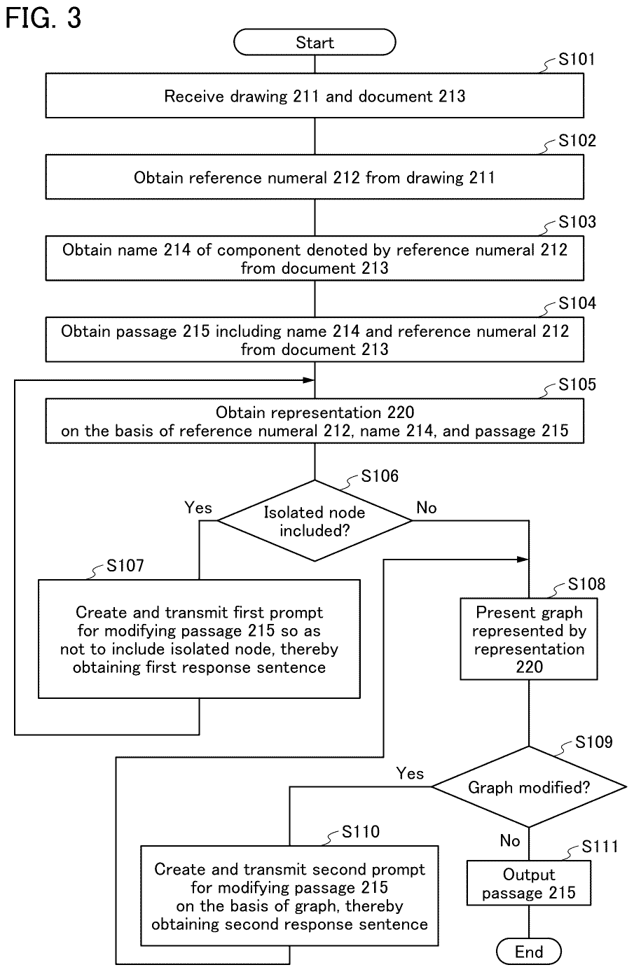

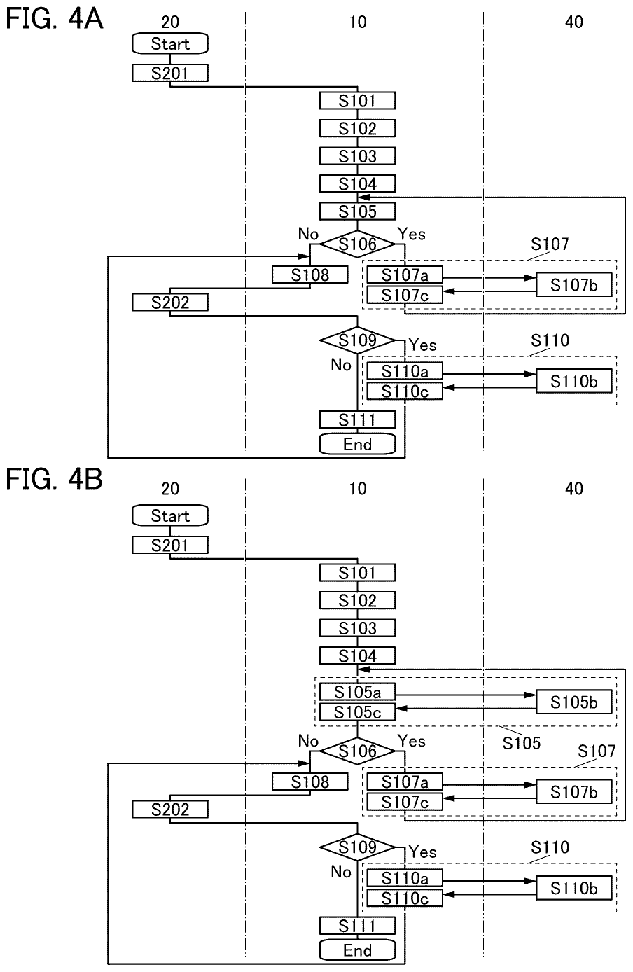

FIG. 3 and FIGS. 4A and 4B are flow charts showing examples of an information processing method of one embodiment of the present invention. FIG. 3 illustrates an example of processes executed by the information processing device 10. FIGS. 4A and 4B show which of the information terminal 20, the information processing device 10, and the information processing device 40 is used for each process.

FIG. 3 shows Step S101 to Step S111. FIGS. 4A and 4B each show Step S201 and Step S202 in addition to Step S101 to Step S111. FIG. 4B is different from FIG. 4A in Step S105.

When the information processing method of one embodiment of the present invention “starts”, Step S201 shown in FIGS. 4A and 4B is performed before Step S101 shown in FIG. 3. In Step S201, the user of the information terminal 20 inputs data including a drawing and a document to the information processing device 10. In other words, in Step S201, the information terminal 20 receives the data and outputs the data to the information processing device 10.

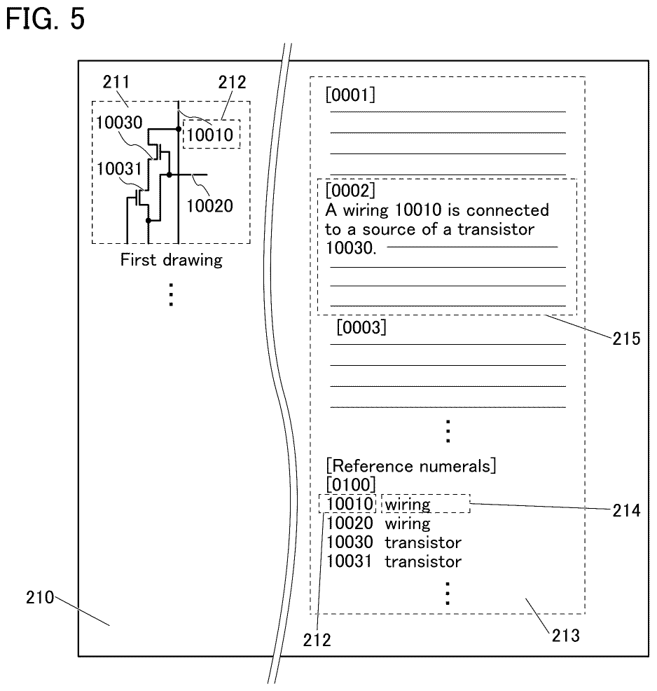

FIG. 5 is a schematic diagram illustrating an example of data 210 that is input to the information processing device 10 in Step S201. In the example illustrated in FIG. 5, the data 210 includes a drawing 211 and a document 213.

The data 210 can be data representing a document for an application related to intellectual property rights. Examples of the application include a patent application and a utility model registration application. In such a case, the document 213 can be a specification.

In this specification and the like, a patent application includes an international patent application. A utility model registration application includes an international utility model registration application. An international patent application refers to an international application that has entered the national (or regional) phase as a patent application. An international utility model registration application refers to an international application that has entered the national (or regional) phase as a utility model registration application. Here, an international application refers to, for example, an application based on the Patent Cooperation Treaty (PCT).

FIG. 5 illustrates a first drawing as the drawing 211. Note that the data 210 can include a plurality of the drawings 211. For example, in the case where the data 210 includes two drawings 211, the data 210 includes a first drawing and a second drawing.

The drawing 211 includes reference numerals. The reference numerals are assigned to the components illustrated in the drawing 211. FIG. 5 illustrates an example in which reference numerals “10010”, “10020”, “10030”, and “10031” are included in the drawing 211. The reference numeral can be represented as text, for example. Alternatively, the reference numeral may be represented as an image.

FIG. 5 illustrates a circuit diagram as an example of the drawing 211, specifically, the first drawing. In the circuit diagram, the reference numerals “10010”, “10020”, “10030”; and “10031” are assigned respectively to a first wiring, a second wiring, a first transistor, and a second transistor. Note that the drawing 211 is not limited to a circuit diagram. For example, the drawing 211 may be a cross-sectional view of a device such as a semiconductor device or a drawing illustrating a method. The method includes a simple method and a method for manufacturing an object.

The document 213 is represented by text. In the example illustrated in FIG. 5, the text included in the document 213 is divided into a plurality of paragraphs. The document 213 includes the description of the drawing 211. The description is made using the reference numerals included in the drawing 211. Moreover, the document 213 includes the section [Reference numerals]. In the section [Reference numerals], the names of the components denoted by the reference numerals included in the drawings 211 are listed.

FIG. 5 shows paragraphs [0001], [0002], [0003], and [0100] included in the document 213. The paragraph [0002] includes “The wiring 10010 is connected to a source of the transistor 10030.” as the description of the drawing 211, specifically, the first drawing. That is, the paragraph [0002] describes the connection relation of the circuit illustrated in the drawing 211, for example. The paragraph [0100] is the section [Reference numerals]. FIG. 5 shows “10010 wiring”, “10020 wiring”, “10030 transistor”, and “10031 transistor” as an example of the section [Reference numerals].

Step S101 shown in FIG. 3 is performed after Step S201 shown in FIGS. 4A and 4B. In Step S101, the reception unit 110 receives the drawing 211 and the document 213. Specifically, the reception unit 110 can receive the data 210 including the drawing 211 and the document 213. Described below is an example in which the reception unit 110 receives the drawing 211, specifically, the first drawing and the document 213 that are illustrated in FIG. 5.

Next, in Step S102 shown in FIG. 3, the processing unit 130 obtains reference numerals from the drawing 211. Specifically, the processing unit 130 obtains the reference numerals “10010”, “10020”, “10030”, and “10031” shown in FIG. 5. The reference numeral obtained from the drawing 211 is referred to as a reference numeral 212. In the case where the reference numeral is represented as text, the processing unit 130 can obtain the reference numeral from the drawing 211 by extracting text contained in the drawing 211. In the case where the reference numeral is represented as an image, the processing unit 130 can obtain the reference numeral from the drawing 211 by performing character recognition on the drawing 211.

Then, in Step S103 shown in FIG. 3, the processing unit 130 obtains a name 214 of a component denoted by the reference numeral 212 from the document 213. The name 214 can be obtained from the section [Reference numerals], for example. In the example illustrated in FIG. 5, the processing unit 130 obtains “wiring” as the name of the component denoted by the reference numeral “10010”. Similarly, the processing unit 130 obtains “wiring” as the name of the component denoted by the reference numeral “10020”. Moreover, the processing unit 130 obtains “transistor” as the name of the component denoted by the reference numeral “10030”. Similarly, the processing unit 130 obtains “transistor” as the name of the component denoted by the reference numeral “10031”. When a plurality of the reference numerals 212 are obtained in Step S102 in the above manner, the respective names 214 are obtained for the reference numerals 212. A set of the name 214 and the reference numeral 212 obtained by the processing unit 130 can be stored in the memory unit 120.

Note that the processing unit 130 may obtain the name 214 of the component denoted by the reference numeral 212 from anywhere other than the section [Reference numerals]. The processing unit 130 may obtain a word, specifically a noun, just before the reference numeral 212, for example, as the name 214 of the component denoted by the reference numeral 212. In this case, the processing unit 130 can obtain the name 214 by performing morphological analysis on the document 213. In the example illustrated in FIG. 5, a noun “wiring” is written just before the reference numeral “10010” in the paragraph [0002]. Therefore, the name of the component denoted by the reference numeral “10010” can be “wiring”.

Subsequently, in Step S104 shown in FIG. 3, the processing unit 130 obtains, from the document 213, a passage (one or more sentences) 215 including the name 214 and the reference numeral 212 that are obtained in the above steps. The processing unit 130 obtains a passage including the above set stored in the memory unit 120 as the passage 215. The passage 215 can be obtained on a paragraph-by-paragraph basis, for example. In the example illustrated in FIG. 5, the paragraph [0002] includes the description “wiring 10010” and “transistor 10030”. Thus, the processing unit 130 obtains the paragraph [0002]. Note that the processing unit 130 can obtain a plurality of paragraphs. The processing unit 130 does not necessarily obtain the passage 215 on a paragraph-by-paragraph basis. That is, only part of the paragraph may be included in the passage 215. The processing unit 130 may obtain the passage 215 on a sentence-by-sentence basis, for example.

Next, in Step S105 shown in FIG. 3, the processing unit 130 obtains a representation 220 on the basis of the reference numerals 212, the names 214, and the passage 215. The representation 220 is represented in a text format in a graph description language. The representation 220 indicates how the components illustrated in the drawing 211 are described in the passage 215. The representation 220 may be created using a language model or may be created by the processing unit 130 without using a language model.

In this specification and the like, a graph description language refers to a language for describing graph structures. A graph has nodes and edges, and two nodes are connected by an edge. Thus, the data structure is shown. An example of a graph description language is a DOT language.

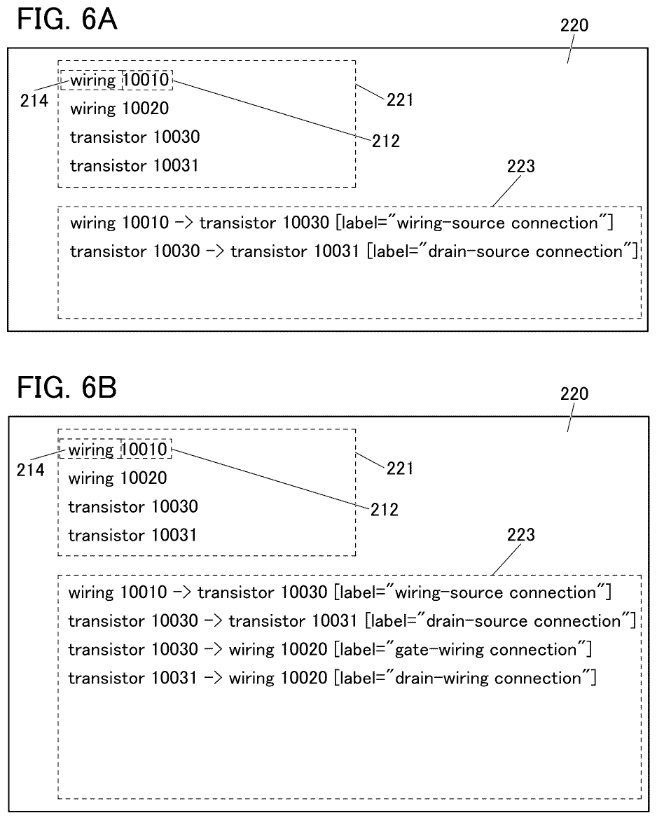

FIG. 6A is a schematic diagram illustrating an example of the representation 220. The representation 220 includes a node representation part 221 and a graph representation part 223.

The node representation part 221 includes the reference numerals 212 and the names 214. A set of one reference numeral 212 and the name 214 of a component denoted by that reference numeral 212 can be used as a node of a graph. That is, the components included in the drawing 211 illustrated in FIG. 5, specifically, the components denoted by reference numerals, can be used as nodes of the graph. In the example illustrated in FIG. 6A, the node representation part 221 includes “wiring 10010”, “wiring 10020”, “transistor 10030”, and “transistor 10031”. In this case, “wiring 10010”, “wiring 10020”, “transistor 10030”, and “transistor 10031” can each be a node. That is, in the example illustrated in FIG. 6A, the node representation part 221 includes four nodes.

The graph representation part 223 indicates a connection relation between nodes included in the node representation part 221, specifically, two nodes connected to each other. The graph representation part 223 also indicates a label. A label represents a relation between two connected nodes. The graph representation part 223 can be regarded as indicating an edge. An edge includes a connection relation between nodes and a label.

As shown in FIG. 5, the passage 215 contains “The wiring 10010 is connected to a source of the transistor 10030”. In the graph representation part 223 illustrated in FIG. 6A, the above is represented as “wiring 10010->transistor 10030 [label=“wiring-source connection”]”. FIG. 6A also illustrates an example in which the graph representation part 223 indicates “transistor 10030->transistor 10031 [label=“drain-source connection”]. This means that the passage 215 contains a statement “a drain of the transistor 10030 is connected to a source of the transistor 10031”. Accordingly, it can be said that the graph representation part 223 indicates two edges in the example illustrated in FIG. 6A.

In the example illustrated in FIG. 6A, the representation 220 represents a directed graph. A directed graph is a graph whose edges have a direction. In FIG. 6A, a direction is denoted by “->”. Here, an example is shown in which the representation 220 represents a directed graph with a subject in the passage 215 as a tail. Note that the representation 220 may represent an undirected graph.

The representation 220 can be created using a language model, for example. FIG. 4B illustrates an example in which the information processing device 40, specifically, the language model of the information processing device 40 is used in Step S105.

In the example illustrated in FIG. 4B, in Step S105a, the processing unit 130 creates a prompt and transmits the prompt to the information processing device 40 through the output unit 140. The prompt is specifically transmitted to the language model of the information processing device 40. The prompt is a prompt for generating the representation 220. The prompt includes the reference numerals 212, the names 214, and the passage 215. The prompt also includes an instruction sentence such as “For the following passage, describe the relation between the following terms in the DOT language. Treat the terms as nodes and make edges contain information on the relation between the terms”.

In Step S105b, the information processing device 40 creates a response sentence on the basis of the above-described prompt by using the language model and supplies the response sentence to the reception unit 110. Thus, in Step S105c, the information processing device 10 obtains the response sentence. The response sentence includes the representation 220. Note that in the case where the processing unit 130 of the information processing device 10 has a function of performing processing using a language model, the processing unit 130 can perform the process in Step S105b. In the case where the processing unit 130 has a function of performing processing using a language model, the processing unit 130 can create a response sentence also in after-mentioned processing using a language model.

The processing unit 130 may modify the representation 220 included in the response sentence. For example, in the case where a node other than the components obtained in Step S102 and Step S103 is included in the representation 220, the node may be deleted from the node representation part 221 and the graph representation part 223. In the case where two or more equivalent edges are included in the graph representation part 223, some of these edges may be deleted.

Note that the representation 220 may be created without using a language model, as shown in FIG. 4A. For example, the information processing device 10 may create the representation 220. The information processing device 10 can create the representation 220 by performing morphological analysis on the passage 215, for example.

Next, in Step S106 shown in FIG. 3, the processing unit 130 determines whether the representation 220 includes an isolated node. In this specification and the like, an isolated node refers to a node that is not connected to another node. Specifically, an isolated node refers to a node that is included in the node representation part 221 in FIG. 6A and is not included in the graph representation part 223. In the example illustrated in FIG. 6A, the wiring 10020 is included in the node representation part 221 but is not included in the graph representation part 223. Thus, the node representing the wiring 10020 is an isolated node. For example, in the case where the connection relation between the wiring 10020 and another component is not explicitly described in the document 213 shown in FIG. 5, the node representing the wiring 10020 is regarded as an isolated node.

When the representation 220 includes an isolated node, the procedure proceeds to Step S107 at the branching point of Step S106 shown in FIG. 3. Step S107 includes Step S107a, Step S107b, and Step S107c as shown in FIGS. 4A and 4B.

In Step S107a, the processing unit 130 creates a first prompt and transmits the first prompt to the information processing device 40 through the output unit 140. The first prompt is specifically transmitted to the language model of the information processing device 40. The first prompt is a prompt for modifying the passage 215 so as not to include an isolated node. The first prompt includes the passage 215, the representation 220, and the drawing 211. The first prompt also includes an instruction sentence such as “For the following passage, add the relation between a term A and another node with reference to the following graphs and drawings”. The “term A” included in the instruction sentence is a term represented by an isolated node. In the example illustrated in FIG. 6A, the wiring 10020 corresponds to the term A.

In Step S107b, the information processing device 40 creates a first response sentence on the basis of the first prompt by using the language model and supplies the first response sentence to the reception unit 110. Thus, in Step S107c, the information processing device 10 obtains the first response sentence. The first response sentence includes the passage 215 that has been modified. The modified passage 215 is referred to as a first modified passage.

After Step S107, Step S105 is performed again. Thus, the representation 220 is created again. In other words, the representation 220 is modified in accordance with the modification of the passage 215. FIG. 6B is a schematic diagram illustrating an example of the modified representation 220. In the example illustrated in FIG. 6B, by the modification of the representation 220 illustrated in FIG. 6A, “transistor 10030->wiring 10020 [label=“gate-wiring connection”] and “transistor 10031->wiring 10020 [label=“drain-wiring connection”]” are added to the graph representation part 223. This is because a passage explicitly stating “a gate of the transistor 10030 is connected to the wiring 10020” and “a drain of the transistor 10031 is connected to the wiring 10020” is added to the passage 215 in Step S107. Accordingly, the processing unit 130 can obtain the representation 220 that does not include an isolated node.

When the representation 220 is created in Step S105 by using the information processing device 40, specifically, the language model of the information processing device 40 as shown in FIG. 4B, both Step S107 and Step S105 can be performed with one prompt. For example, when the instruction sentence included in the first prompt contains a sentence such as “Describe the modified passage in the DOT language. Make the nodes have the same graph structure as the following graph structure written in the DOT language.” in addition to the above-described sentence, both Step S107 and Step S105 can be executed with one prompt. After Step S105, the processing unit 130 determines in Step S106 whether the representation 220 includes an isolated node.

When the representation 220 does not include an isolated node, the procedure proceeds to Step S108 at the branching point of Step S106 shown in FIG. 3. In Step S108, the processing unit 130 presents a graph represented by the representation 220 to the user of the information processing system. For example, the processing unit 130 visualizes the graph represented by the representation 220 and supplies the image data to the information terminal 20 through the output unit 140. Thus, the graph represented by the representation 220 is displayed on the display portion of the information terminal 20. After Step S108, an input from the user of the information processing system is received in Step S202 shown in FIGS. 4A and 4B. Examples of the input include selection and modification that will be described later.

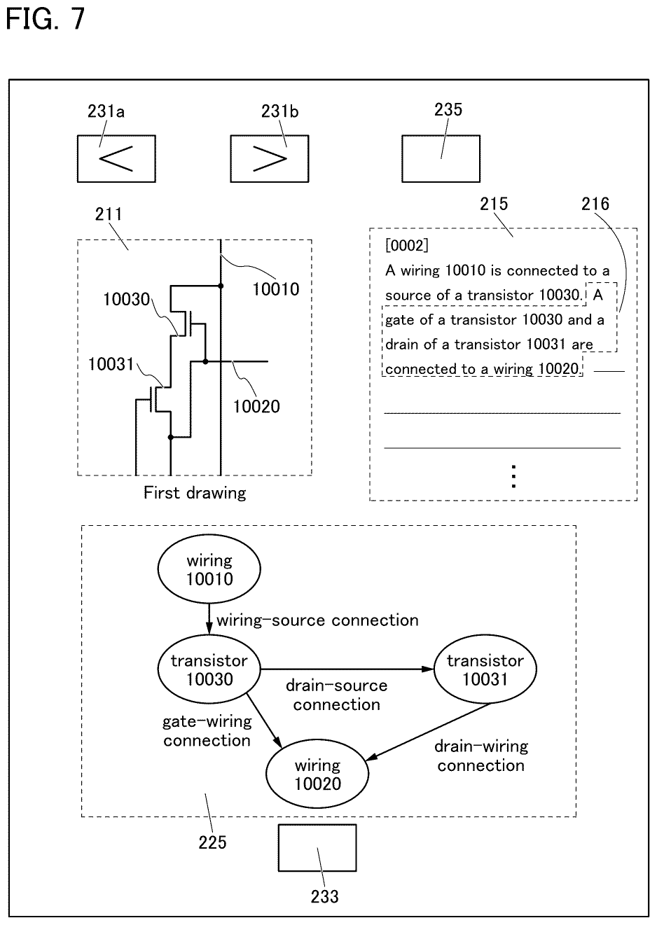

FIG. 7 illustrates an example of information that is displayed on the display portion of the information terminal 20 in Step S108. FIG. 7 can be regarded as showing an example of a graphical user interface (GUI) relating to the information processing system of one embodiment of the present invention. A form, an icon, a table, and the like in diagrams relating to a GUI exemplified in this embodiment, such as FIG. 7, are merely examples and are not intended to be limiting. A GUI can be constructed as a web page accessed by the user of the information processing system via the network 30. Alternatively, a GUI can be constructed as a screen of a program application executed on the information terminal 20.

The example illustrated in FIG. 7 shows the drawing 211, the passage 215, a passage 216, and a graph 225. That is, in the example of FIG. 7, the drawing 211, the passage 215, the passage 216, and the graph 225 are presented to the user of the information processing system. In the example of FIG. 7, the processing unit 130 performs a process of presenting the drawing 211, the passage 215, and the passage 216 to the user while presenting the graph 225 to the user. The first drawing is specifically illustrated as the drawing 211. The example of FIG. 7 also shows a button 231a, a button 231b, a button 233, and a button 235.

The passage 216 is a passage that is revised or modified, for example, in the case where the passage 215 is modified in Step S107 or the like. The passage 216 is part of the passage 215. FIG. 7 illustrates an example in which a sentence “A gate of the transistor 10030 and a drain of the transistor 10031 are connected to the wiring 10020.” is added as the passage 216 to follow the sentence “The wiring 10010 is connected to a source of the transistor 10030.” included in the passage 215 illustrated in FIG. 5. That is, FIG. 7 illustrates an example of the passage 215 that has been modified in Step S107 or the like.

In the representation 220 illustrated in FIG. 6A, the node representing the wiring 10020 is an isolated node as described above. The reason why the node representing the wiring 10020 is an isolated node is that the connection relation between the wiring 10020 and another component is not explicitly described in the document 213 illustrated in FIG. 5, as described above. FIG. 7 illustrates an example in which the passage 216 representing the connection relation between the wiring 10020 and other components is added to the passage 215 in Step S107, and thus an isolated node is excluded from the representation 220 as illustrated in FIG. 6B. Note that the passage 216 may be emphasized. Examples of emphasis methods include changing the background color, changing the text color, increasing the font size, changing the font, bolding, and underlining.

Although FIG. 7 illustrates an example in which only the passage 215 in the document 213 illustrated in FIG. 5 is displayed on the display portion of the information terminal 20, a passage other than the passage 215 may be displayed. For example, the entire document 213 may be displayed on the display portion of the information terminal 20. In this case, it is preferable to make the passage 215 distinguishable for the user of the information processing system from other passages. For example, the passage 215 can be visually distinguished from other passages by being surrounded with a frame. Moreover, the passage 215 can be visually distinguished from other passages by being emphasized by any of the above methods, for example.

The graph 225 shown in FIG. 7 is a graph represented by the representation 220 shown in FIG. 6B. In the example illustrated in FIG. 7, a node included in the node representation part 221 is represented by an ellipse. An edge represented by the graph representation part 223 is indicated by an arrow. A label is shown near an arrow. It is also possible that labels are not displayed near the arrows; instead, the user of the information processing system can select an edge (i.e., arrow) so that the label assigned to the selected edge is displayed. An edge can be selected with a mouse or a keyboard, for example. In the case where the information terminal 20 is provided with a touch sensor, the user of the information terminal 20 can select an edge by touching an arrow displayed on the display portion.

In Step S202 shown in FIGS. 4A and 4B, when the user of the information processing system selects the button 231b, the processing result for the next drawing 211 is displayed on the display portion of the information terminal 20. Specifically, in the case where the processing result for the first drawing is displayed as illustrated in FIG. 7, the processing result for the second drawing is displayed by selecting the button 231b. For example, the passage 215 obtained by performing Step S102 to Step S107 in FIG. 3 with respect to the second drawing is displayed. Moreover, a graph represented by the representation 220 obtained on the basis of the thus obtained passage 215 is displayed as the graph 225. When the user of the information processing system selects the button 231a, the processing result for the previous drawing 211 is displayed on the display portion of the information terminal 20. For example, in the case where the processing result for the second drawing is displayed, the processing result for the first drawing is displayed by selecting the button 231a.

The button 231a and the button 231b can be selected with a mouse or a keyboard, for example. In the case where the information terminal 20 is provided with a touch sensor, the user of the information terminal 20 can select the button 231a by touching the button 231a displayed on the display portion, and can select the button 231b by touching the button 231b. Note that the button 233 and the button 235 can be selected in the same manner as the button 231a and the button 231b.

In Step S202 shown in FIGS. 4A and 4B, the user of the information processing system can modify the drawing 211, the passage 215, and the graph 225. In the case where passages other than the passage 215 are displayed on the display portion of the information terminal 20, the passages other than the passage 215 can be modified. For example, in the case where all passages included in the document 213 are displayed, all the passages included in the document 213 can be modified.

The graph 225 is modified by the user of the information processing system so as not to be inconsistent with the drawing 211, for example. In the case where a component desired to be written in the passage 215 is not shown in the graph 225, the user of the information processing system can modify the graph 225 to represent the component. In the case where the user of the information processing system adds a reference numeral to the drawing 211, for example, a node can be added to the graph 225. The user of the information processing system selects the button 233 after modifying the graph 225.

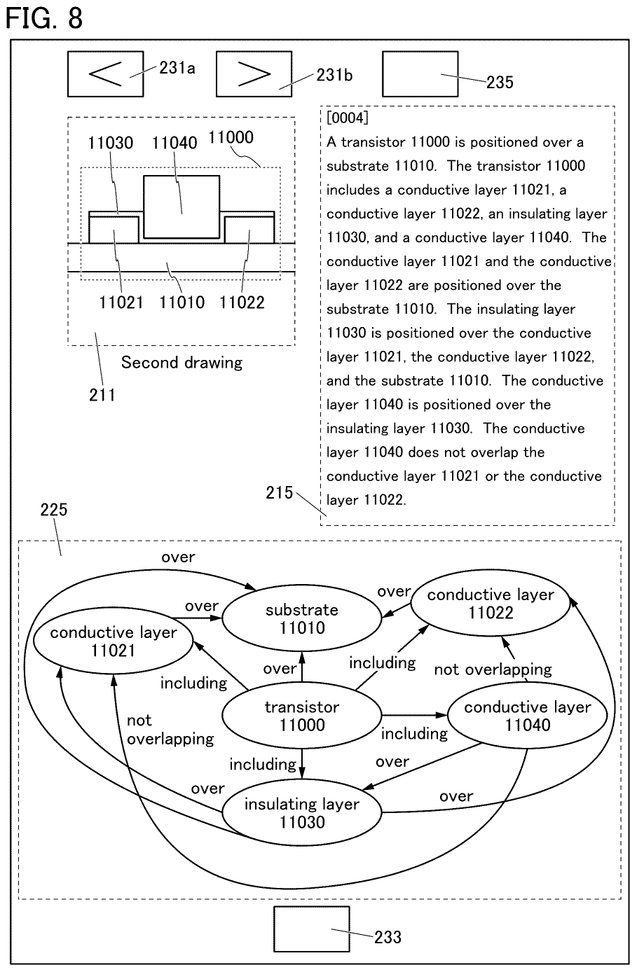

FIG. 8 illustrates an example of information that is displayed on the display portion of the information terminal 20 in Step S108, and can be regarded as a diagram relating to a GUI, like FIG. 7. FIG. 8 illustrates an example in which the second drawing is displayed on the display portion of the information terminal 20.

In the example illustrated in FIG. 8, a schematic cross-sectional view of a transistor is shown as the drawing 211. In the example of FIG. 8, a paragraph [0004] is shown as the passage 215. The paragraph [0004] contains “A transistor 11000 is positioned over a substrate 11010. The transistor 11000 includes a conductive layer 11021, a conductive layer 11022, an insulating layer 11030, and a conductive layer 11040. The conductive layer 11021 and the conductive layer 11022 are positioned over the substrate 11010. The insulating layer 11030 is positioned over the conductive layer 11021, the conductive layer 11022, and the substrate 11010. The conductive layer 11040 is positioned over the insulating layer 11030. The conductive layer 11040 does not overlap the conductive layer 11021 or the conductive layer 11022.”

The graph 225 shown in FIG. 8 includes nodes “transistor 11000”, “substrate 11010”, “conductive layer 11021”, “conductive layer 11022”, “insulating layer 11030”, and “conductive layer 11040”. The nodes are connected by edges represented by arrows. One of the terms “over”, “including”, and “not overlapping” that are included in the passage 215 is assigned to each edge as a label. Note that in the example illustrated in FIG. 8, the graph 225 is a directed graph, and the node serving as the subject in the passage 215 is the tail.

As illustrated in FIG. 8, the graph 225 can represent the inclusion relation and the positional relation between the components shown in the drawing 211. In the example illustrated in FIG. 8, “including” is a label representing an inclusion relation. Moreover, “over” and “not overlapping” are labels representing a positional relation. Note that in the information processing system of one embodiment of the present invention, all the components included in the passage 215 are not necessarily represented by the graph 225. For example, in the example of FIG. 8, the graph 225 may represent only the positional relation without representing the inclusion relation.

For example, the GUI illustrated in FIG. 8 can be displayed by selecting the button 231b illustrated in FIG. 7. The GUI illustrated in FIG. 7 can be displayed by selecting the button 231a illustrated in FIG. 8.

When the graph 225 is modified and then the button 233 is selected, the procedure proceeds to Step S110 at the branching point of Step S109 shown in FIG. 3. Step S110 includes Step S110a, Step S110b, and Step S110c as shown in FIGS. 4A and 4B.

In Step S110a, the processing unit 130 creates a second prompt and transmits the second prompt to the information processing device 40 through the output unit 140. The second prompt is specifically transmitted to the language model of the information processing device 40. The second prompt is a prompt for modifying the passage 215 on the basis of the modified graph 225. The second prompt includes the graph 225, the passage 215, and the drawing 211, for example. The second prompt also includes an instruction sentence such as “Modify the following passage to represent the following graph”.

Here, after the button 233 is selected, the processing unit 130 may express the graph 225 in a text format using a graph description language. In this case, the second prompt can include text representing the graph 225 instead of the graph 225 itself. In the case where the user of the information processing system modifies the passage 215 in Step S202 shown in FIGS. 4A and 4B, the modified passage 215 can be included in the second prompt. Similarly, in the case where the user of the information processing system modifies the drawing 211, the modified drawing 211 can be included in the second prompt.

In Step S110b, the information processing device 40 creates a second response sentence on the basis of the second prompt by using the language model and supplies the second response sentence to the reception unit 110. Thus, in Step S110c, the information processing device 10 obtains the second response sentence. The second response sentence includes the modified passage 215. The modified passage 215 is referred to as a second modified passage.

In this specification and the like, in the case where the prompt created by the processing unit 130 in Step S107a in FIGS. 4A and 4B is the first prompt and the prompt created by the processing unit 130 in Step S110a is the second prompt, the prompt created by the processing unit 130 in Step S105a in FIG. 4B can be a third prompt. The response sentence generated by the language model in Step S105b in FIG. 4B can be a third response sentence.

When the button 233 is selected, the passage 215 displayed on the display portion of the information terminal 20, for example, is modified in Step S110. For example, when the button 233 is selected while the first drawing is displayed on the display portion of the information terminal 20 as illustrated in FIG. 7, the passage 215 for describing the first drawing is modified. When the button 233 is selected while the second drawing is displayed on the display portion of the information terminal 20, the passage 215 for describing the second drawing is modified.

After Step S110, Step S108 is performed again. Thus, the user of the information processing system can check the modified passage 215 and remodify it as needed.

When determining that the modification of the graph 225 is unnecessary, the user of the information processing system selects the button 235. When selecting the button 231b or the like and determining that the modification of all the graphs 225 is unnecessary, the user of the information processing system selects the button 235. Here, the user of the information processing system selects the button 235 after the modification of the passage 215 and the drawing 211 is completed. When the button 235 is selected, the procedure proceeds to Step S111 at the branching point of Step S109 shown in FIG. 3.

In Step S111, the processing unit 130 outputs the passage 215. The processing unit 130 supplies the passage 215 to the memory unit 120, for example, through the output unit 140. The processing unit 130 can supply the passage 215 to the information terminal 20, for example, through the output unit 140. The passage 215 supplied to the information terminal 20 can be stored in the information terminal 20, for example. Here, the passage 215 may be or may not be presented to the user of the information processing system. For example, the passage 215 may be or may not be displayed on the display portion of the information terminal 20. Note that in the case where the drawing 211 is modified in Step S202 shown in FIGS. 4A and 4B, the processing unit 130 outputs the drawing 211 in Step S111. In Step S111, the processing unit 130 may output the graph 225.

Accordingly, the information processing method of one embodiment of the present invention “ends”.

As described above, with the use of the information processing system of one embodiment of the present invention, all the components illustrated in the drawing 211 can be included in the document 213 illustrated in FIG. 5. Thus, a highly complete document can be created. Moreover, the user can create a document with a small amount of workload. Accordingly, one embodiment of the present invention can provide an information processing device, an information processing method, and an information processing system that are highly convenient and useful.

### <Structure Example 2 of Information Processing System>

A detailed structure example of the information processing system of one embodiment of the present invention is described below. Specifically, structure examples of the memory unit 120, the processing unit 130, and the network 30 that are not shown in <Structure example 1 of information processing system> are described.

The memory unit 120 includes at least one of a volatile memory and a nonvolatile memory. Examples of the volatile memory include a dynamic random access memory (DRAM) and a static random access memory (SRAM). Examples of the nonvolatile memory include a resistive random access memory (ReRAM, also referred to as a resistance-change memory), a phase-change random access memory (PRAM), a ferroelectric random access memory (FeRAM), a magnetoresistive random access memory (MRAM, also referred to as a magnetoresistive memory), and a flash memory. The memory unit 120 may include at least one of a NOSRAM (registered trademark) and a DOSRAM (registered trademark). The memory unit 120 may include a recording media drive. Examples of the recording media drive include a hard disk drive (HDD) and a solid-state drive (SSD).

Note that “NOSRAM” is an abbreviation for “nonvolatile oxide semiconductor random access memory”. The NOSRAM refers to a memory in which a two-transistor (2T) or three-transistor (3T) gain cell is used as a memory cell and each transistor includes a metal oxide in its channel formation region (such a transistor is also referred to as an OS transistor). The OS transistor has an extremely low current that flows between a source and a drain in an off state, that is, an extremely low leakage current. The NOSRAM retains electric charge corresponding to data in memory cells with the use of the characteristics of extremely low leakage current, thereby capable of being used as a nonvolatile memory. In particular, the NOSRAM is capable of reading retained data without destruction (non-destructive reading), and thus is suitable for arithmetic processing in which only data reading operations are repeated many times. The NOSRAM can have large data capacity when stacked in layers; hence, a semiconductor device in which the NOSRAM is used for a large-scale cache memory, a large-scale main memory, a large-scale storage memory, or the like can have higher performance.

The DOSRAM is an abbreviation for “dynamic oxide semiconductor RAM” and refers to a RAM including a one-transistor (1T) and one-capacitor (1C) memory cell. The DOSRAM is a DRAM formed using an OS transistor and temporarily stores data sent from the outside. The DOSRAM is a memory utilizing a low off-state current of an OS transistor.

In this specification and the like, a metal oxide means an oxide of a metal in a broad sense. Metal oxides are classified into an oxide insulator, an oxide conductor (including a transparent oxide conductor), an oxide semiconductor (also simply referred to as an OS), and the like. For example, a metal oxide used in a semiconductor layer of a transistor is referred to as an oxide semiconductor in some cases.

A metal oxide included in a channel formation region preferably contains indium (In), and for example, indium oxide is preferably used. When the metal oxide included in the channel formation region is a metal oxide containing indium, the carrier mobility (electron mobility) of the OS transistor is high. The metal oxide included in the channel formation region is preferably an oxide semiconductor containing an element M. The element M is preferably at least one of aluminum (Al), gallium (Ga), and tin (Sn). Other elements that can be used as the element M are boron (B), silicon (Si), titanium (Ti), iron (Fe), nickel (Ni), germanium (Ge), yttrium (Y), zirconium (Zr), molybdenum (Mo), lanthanum (La), cerium (Ce), neodymium (Nd), hafnium (Hf), tantalum (Ta), tungsten (W), and the like. Note that a combination of two or more of the above elements may be used as the element M. The element M is, for example, an element that has high bonding energy with oxygen. The element M is, for example, an element that has higher bonding energy with oxygen than indium. The metal oxide included in the channel formation region is preferably a metal oxide containing zinc (Zn). The metal oxide containing zinc is easily crystallized in some cases.

The metal oxide included in the channel formation region is not limited to the metal oxide containing indium. The metal oxide in the channel formation region may be, for example, a metal oxide that does not contain indium but contains any of zinc, gallium, and tin (e.g., zinc tin oxide or gallium tin oxide).

The processing unit 130 can include an arithmetic circuit, for example. The processing unit 130 can include, for example, a central processing unit (CPU). The processing unit 130 can also include a graphics processing unit (GPU).

The processing unit 130 may include a microprocessor such as a digital signal processor (DSP). The microprocessor may be configured with a programmable logic device (PLD) such as a field programmable gate array (FPGA) or a field programmable analog array (FPAA). The processing unit 130 may include a quantum processor. With a processor, the processing unit 130 can interpret and execute instructions from various kinds of programs to process various kinds of data and control programs. The programs to be executed by the processor are stored in at least one of the memory unit 120 and a memory region of the processor.

The processing unit 130 may include a main memory. The main memory includes at least one of a volatile memory such as a random access memory (RAM) and a nonvolatile memory such as a read only memory (ROM). The main memory may include at least one of the above-described NOSRAM and DOSRAM.

Examples of the RAM include a DRAM and an SRAM; a virtual memory space is assigned and utilized as a working space of the processing unit 130. An operating system, an application program, a program module, program data, a look-up table, and the like that are stored in the memory unit 120 are loaded into the RAM for execution. The data, program, and program module that are loaded into the RAM are each directly accessed and operated by the processing unit 130.

The ROM can store a basic input/output system (BIOS), firmware, and the like for which rewriting is not needed. Examples of the ROM include a mask ROM, a one-time programmable read only memory (OTPROM), and an erasable programmable read only memory (EPROM). Examples of the EPROM include an ultraviolet erasable programmable read only memory (UV-EPROM) which can erase stored data by irradiation with ultraviolet rays, an electrically erasable programmable read only memory (EEPROM), and a flash memory.

The processing unit 130 can include one or both of an OS transistor and a transistor including silicon in its channel formation region (a Si transistor).

The processing unit 130 preferably includes an OS transistor. Since the OS transistor has an extremely low off-state current, a long data retention period can be ensured with the use of the OS transistor as a switch for retaining electric charge (data) that has flowed into a capacitor functioning as a memory element. When at least one of a register and a cache memory included in the processing unit 130 has such a feature, the processing unit 130 can be operated only when needed, and otherwise can be turned off after information on the immediately preceding process is stored in the memory element. In other words, normally-off computing is possible and the power consumption of the information processing system can be reduced.

As the network 30, the Internet, which is a global network and works as the infrastructure of the World Wide Web (WWW), can be used, for example. Moreover, a local network can be used as the network 30. An intranet or an extranet can be used as the network 30. A personal area network (PAN), a local area network (LAN), a campus area network (CAN), a metropolitan area network (MAN), a wide area network (WAN), a global area network (GAN), or the like can be used as the network 30.

In the case where a service provider using the information processing method of one embodiment of the present invention and the user who enjoys the service belong to the same organization such as a company, data transmission and reception between the information terminal 20 and the information processing device 10 is preferably performed using a network constructed in the organization, for example. Thus, data can be transmitted and received between the information terminal 20 and the information processing device 40 more safely than in the case where data is transmitted via the Internet. In addition, confidential information in the organization can be prevented from leaking to the outside.

Note that as communication protocols or communication technology for wireless communication, it is possible to use communication standards such as the fourth-generation mobile communication system (4G), the fifth-generation mobile communication system (5G), or the sixth-generation mobile communication system (6G); or communication standards developed by the Institute of Electrical and Electronics Engineers (IEEE), such as Wi-Fi (registered trademark) or Bluetooth (registered trademark).

This application is based on Japanese Patent Application Serial No. 2025-018155 filed with Japan Patent Office on Feb. 6, 2025, the entire contents of which are hereby incorporated by reference.

What is claimed is:

1. An information processing method comprising the steps of:
receiving a drawing and a document;
obtaining a reference numeral from the drawing, a name of a component denoted by the reference numeral from the document, and a passage comprising the name and the reference numeral from the document;
obtaining a first representation comprising a node representing the component by using a graph description language based on the reference numeral, the name, and the passage;
obtaining a first modified passage by transmitting, to a language model, a first prompt for modifying the passage so that an isolated node is excluded from the first representation;
obtaining a second representation by using the graph description language based on the reference numeral, the name, and the first modified passage;
presenting a graph represented by the second representation;
receiving a modified graph;
obtaining a second modified passage by transmitting, to the language model, a second prompt for modifying the first modified passage based on the modified graph; and
outputting the second modified passage.

2. An information processing method comprising:
a first step of receiving a drawing and a document;
a second step of obtaining a reference numeral from the drawing;
a third step of obtaining a name of a component denoted by the reference numeral from the document;
a fourth step of obtaining a passage comprising the name and the reference numeral from the document;
a fifth step of obtaining a first representation by using a graph description language based on the reference numeral, the name, and the passage, wherein the first representation represents a graph comprising at least two nodes and at least one edge, the node represents the component, and the edge represents a relation between two of the nodes;
a sixth step of creating a first prompt for modifying the passage so that an isolated node is excluded from the first representation when the first representation comprises the isolated node and transmitting the first prompt to a language model to obtain a first modified passage; followed by the fifth step using the first modified passage;
a seventh step of presenting the graph when the first representation does not comprise the isolated node;
an eighth step of creating a second prompt for modifying the passage based on a modified graph when the graph is modified and transmitting the second prompt to the language model to obtain a second modified passage; followed by the seventh step using the second modified passage; and
a ninth step of outputting the passage when the graph is not modified.

3. The information processing method according to claim 2,
wherein the drawing and the passage are also presented in the seventh step.

4. The information processing method according to claim 2,
wherein the first representation is obtained in the fifth step by creating a third prompt for generating the first representation and transmitting the third prompt to the language model.

5. The information processing method according to claim 2,
wherein the document is a specification for a patent application or a specification for a utility model registration application, and
wherein the drawing relates to the patent application or the utility model registration application.

6. The information processing method according to claim 2,
wherein the graph description language is a DOT language.

7. An information processing device comprising:
a reception unit configured to receive a document and a drawing;
a processing unit configured to:
obtain a reference numeral from the drawing;
obtain a name of a component denoted by the reference numeral from the document;
obtain a passage comprising the name and the reference numeral from the document;
obtain a first representation representing a graph comprising at least two nodes and at least one edge by using a graph description language based on the reference numeral, the name, and the passage;
create a first prompt for modifying the passage so that an isolated node is excluded from the first representation when the first representation comprises the isolated node;
present the graph to a user when the first representation does not comprise the isolated node; and
create a second prompt for modifying the passage based on a modified graph when the graph is modified by the user; and
an output unit configured to supply the first prompt and the second prompt to the language model and output the passage,
wherein the node represents the component, and
wherein the edge represents a relation between two of the nodes.

8. The information processing device according to claim 7,
wherein the processing unit is configured to present the drawing and the passage to the user while presenting the graph to the user.

9. The information processing device according to claim 7,
wherein the processing unit is configured to create a third prompt for generating the first representation, and
wherein the output unit is configured to supply the third prompt to the language model.

10. The information processing device according to claim 7,
wherein the document is a specification for a patent application or a specification for a utility model registration application, and
wherein the drawing relates to the patent application or the utility model registration application.

11. The information processing device according to claim 7,
wherein the graph description language is a DOT language.
